(19) United States
(12) Patent Application Publication
(10) Pub. No.: US 2016/0266294 A1
(43) Pub. Date: Sep. 15, 2016

(54) WIRE GRID POLARIZER AND METHOD OF FABRICATING THE SAME

(71) Applicant: Samsung Display Co. Ltd., Yongin-City (KR)

(72) Inventors: Dae Ho YOON, Seoul (KR); Lei XIE, Suwon-si (KR); Seung Won PARK, Seoul (KR); Moon Gyu LEE, Suwon-si (KR)

(21) Appl. No.: 14/838,358

(22) Filed: Aug. 27, 2015

(30) Foreign Application Priority Data
Mar. 9, 2015 (KR) 10-2015-0032344

(51) Int. Cl. G02B 5/30

(52) U.S. Cl. CPC G02B 5/3058

(57) ABSTRACT

A wire grid polarizer includes a substrate, a plurality of conductive wire patterns which protrudes from a surface of the substrate and each extends in a direction to be substantially parallel to each other, a flaw which is provided in at least one of the conductive wire patterns and protrudes in a direction different from the direction in which the conductive wire patterns extend, and a blocking portion which blocks the flaw.

This application claims priority to Korean Patent Application 10-2015-0032344 filed on Mar. 9, 2015, and all the benefits accruing therefrom under 35 U.S.C. 119, the content of which in its entirety is herein incorporated by reference.

### BACKGROUND

1. Field

The invention relates to a wire grid polarizer and a method of fabricating the same.

2. Description of the Related Art

A wire grid is an array of conductive wires arranged in parallel to polarize light having a predetermined polarization in electromagnetic waves.

A wire grid structure having a shorter period than a wavelength of corresponding light reflects light of a polarization parallel to the wires among unpolarized incident light and transmits light of a polarization perpendicular to the wires. Thus, the wire grid may reuse reflected polarized light, unlike an absorptive polarizer.

### SUMMARY

Unwanted flaws may be provided in the process of arranging parallel conductive wires. Due to these flaws, unwanted light may transmit through the wire grid. Ultimately, the flaws of the wire grid may cause bright spot defects in a display device.

Exemplary embodiments of the invention provide a wire grid polarizer which may minimize bright spot defects.

Exemplary embodiments of the invention also provide a method of fabricating a wire grid polarizer in such a way to repair flaws provided in the process of fabricating the wire grid polarizer.

However, exemplary embodiments of the invention are not restricted to the one set forth herein. The above and other exemplary embodiments of the invention will become more apparent to one of ordinary skill in the art to which the invention pertains by referencing the detailed description of the invention given below.

According to an exemplary embodiment, there is provided a wire grid polarizer including a substrate, a plurality of conductive wire patterns which protrudes from a surface of the substrate and each extends in a direction to be substantially parallel to each other, a flaw which is provided in at least one of the conductive wire patterns and protrudes in a direction different from the direction in which the conductive wire patterns extend, and a blocking portion which blocks the flaw.

In an exemplary embodiment, the blocking portion may be integrally provided with a conductive wire pattern having the flaw.

In an exemplary embodiment, the blocking portion may wider than the conductive wire pattern having the flaw.

In an exemplary embodiment, distances between the blocking portion and conductive wire patterns adjacent to both sides of the conductive wire pattern having the blocking portion may equal to or smaller than a distance between conductive wire patterns without blocking portions.

In an exemplary embodiment, the blocking portion may include the same material as the conductive wire pattern having the flaw.

In an exemplary embodiment, the blocking portion may be located on the conductive wire pattern having the flaw.

In an exemplary embodiment, the blocking portion may be located on the conductive wire pattern having the flaw and a conductive wire pattern adjacent to the conductive wire pattern.

In an exemplary embodiment, the blocking portion may blocks light in a visible wavelength range.

In an exemplary embodiment, the blocking portion may include a negative photosensitive resin composition.

In an exemplary embodiment, the wire grid polarizer may further include a reflective layer located on the substrate between the conductive wire patterns.

In another exemplary embodiment there is provided a method of fabricating a wire grid polarizer, the method including forming a pattern layer on a substrate, forming conductive wire patterns by patterning the pattern layer, and melting a flaw provided in at least one of the conductive wire patterns.

In an exemplary embodiment, the melting of the flaw may be performed by irradiating a laser beam to the flaw.

In an exemplary embodiment, the laser beam may be irradiated toward the conductive wire patterns from a surface of the substrate.

In an exemplary embodiment, the method may further include detecting the flaw before the melting of the flaw.

In another exemplary embodiment there is provided a method of fabricating a wire grid polarizer, the method including forming a pattern layer on a surface of a substrate, forming conductive wire patterns by patterning the pattern layer, coating a photosensitive layer, which includes a photosensitive resin composition, on the conductive wire patterns, forming a blocking portion by exposing the photosensitive layer to light, and removing the photosensitive layer excluding the blocking portion.

In an exemplary embodiment, the photosensitive resin composition may include a negative photosensitive resin composition.

In an exemplary embodiment, the blocking portion may block light in a visible wavelength range.

In an exemplary embodiment, the forming the blocking portion may be performed by irradiating light toward the photosensitive layer from the other surface of the substrate.

In an exemplary embodiment, the conductive wire patterns may be arranged in a direction to be substantially parallel to each other, and the light is light of a first polarization parallel to the direction in which the conductive wire patterns are arranged.

In an exemplary embodiment, the forming the blocking portion may include transmitting the light of the first polarization through the conductive wire patterns and letting a portion of the photosensitive layer, which is exposed to the transmitted light, be cured.

### BRIEF DESCRIPTION OF THE DRAWINGS

The above and other exemplary embodiments, advantages and features of the invention will become more apparent by describing in detail exemplary embodiments thereof with reference to the attached drawings, in which:

FIG. 1 is a perspective view of an exemplary embodiment of a wire grid polarizer according to the invention;

FIG. 2 is a plan view of the wire grid polarizer of FIG. 1;

FIG. 3 is a cross-sectional view of the wire grid polarizer taken along line A-A′ of FIG. 1;

FIG. 4 is a perspective view of another exemplary embodiment of a wire grid polarizer according to the invention;

FIGS. 5, 6, 7, 8, 9, 10 and 11 are schematic views illustrating an exemplary embodiment a method of fabricating a wire grid polarizer according to the invention;

FIG. 12 is a cross-sectional view of another exemplary embodiment of a wire grid polarizer according to the invention;

FIG. 13 is a cross-sectional view of another exemplary embodiment of a wire grid polarizer according to the invention;

FIG. 14 is a schematic cross-sectional view of an exemplary embodiment of a lower panel of a display device according to the invention;

FIG. 15 is a schematic cross-sectional view of another exemplary embodiment of a lower panel of a display device according to the invention;

FIG. 16 is a perspective view of another exemplary embodiment of a wire grid polarizer according to the invention;

FIG. 17 is a cross-sectional view taken along line C-C′ of FIG. 16;

FIG. 18 is a cross-sectional view of another exemplary embodiment of a wire grid polarizer according to the invention;

FIG. 19 is a schematic cross-sectional view of another exemplary embodiment of a lower panel of a display device according to the invention;

FIG. 20 is a schematic cross-sectional view of another exemplary embodiment of a lower panel of a display device according to the invention; and

FIGS. 21, 22, 23, 24 and 25 are schematic views illustrating a method of fabricating the wire grid polarizer of FIG. 16.

### DETAILED DESCRIPTION

Features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided so that this invention will be thorough and complete and will fully convey the concept of the invention to those skilled in the art, and the invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, a region illustrated as a rectangle may have rounded or curved features and/or a gradient at its edges rather than a binary change from the region. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which the invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

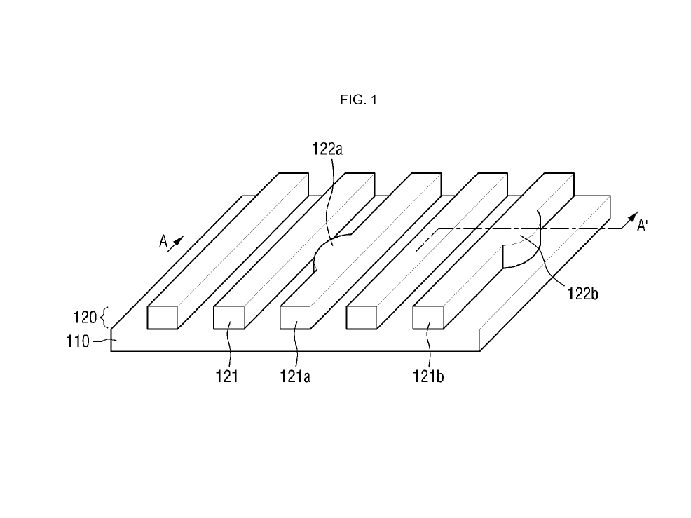

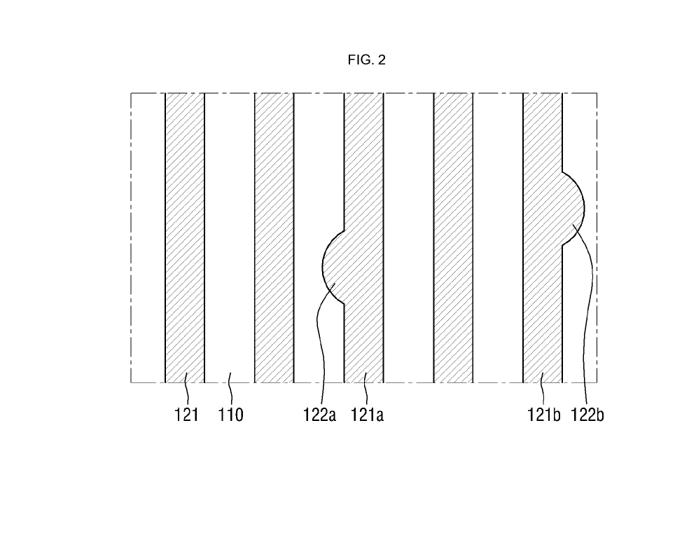

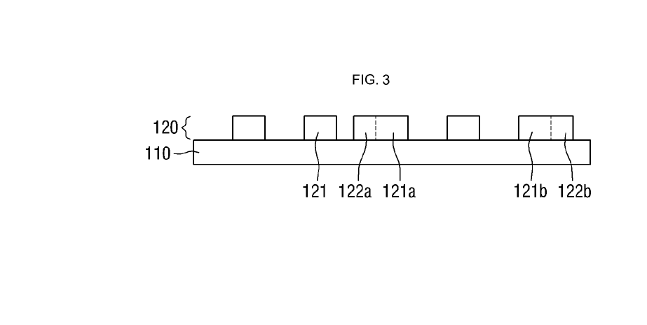

FIG. 1 is a perspective view of a wire grid polarizer according to an exemplary embodiment of the invention. FIG. 2 is a plan view of the wire grid polarizer of FIG. 1. FIG. 3 is a cross-sectional view of the wire grid polarizer taken along line A-A′ of FIG. 1.

Referring to FIGS. 1 through 3, the wire grid polarizer according to the current embodiment may include a substrate 110, a plurality of conductive wire patterns 120 which protrude from a surface of the substrate 110 and extend in a direction to be substantially parallel to each other, and blocking portions 122a and 122b which block flaws provided in at least some of the conductive wire patterns 120, and which protrude in a direction different from the direction in which the conductive wire patterns 120 extend.

The substrate 110 may include any material that may transmit visible light. The material that forms the substrate 110 may be selected according to use or process. Examples of the material may include various polymers such as, but not limited to, glass, quartz, acrylic, triacetylcellulose (“TAC”), cyclic olefin copolymer (“COP”), cyclic olefin polymer (“COC”), polycarbonate (“PC”), polyethylene naphthalate (“PET”), and polyether sulfone (“PES”). The substrate 110 may include an optical film material having a certain degree of flexibility.

The conductive wire patterns 120 may be disposed on the substrate 110 to protrude from the surface of the substrate 110 and arranged parallel to each other with a predetermined period. That is, the conductive wire patterns 120 may be arranged substantially parallel to each other in a direction with a predetermined interval. The conductive wire patterns 120 may have a higher polarization extinction ratio as the period of the conductive wire patterns 120 is shorter than a wavelength of incident light. However, the shorter the period of the conductive wire patterns 120, the more difficult it is to fabricate the conductive wire patterns 120. In an exemplary embodiment, a visible region ranges from about 380 nanometers (nm) to about 780 nm, for example. In an exemplary embodiment, in order for the wire grid polarizer to have a high extinction ratio for three primary colors (e.g., red, green and blue) of light, the conductive wire patterns 120 have a period of at least about 200 nm or less so that polarization characteristics are expected. In an exemplary embodiment, in order for the wire grid polarizer to have polarization performance equivalent to or higher than a conventional polarizer, the conductive wire patterns 120 have a period of about 120 nm or less, for example.

The conductive wire patterns 120 may include any conductive material. In an exemplary embodiment, the conductive wire patterns 120 may include a metal material, more specifically, a metal including, but not limited to, aluminum (Al), chrome (Cr), silver (Ag), copper (Cu), nickel (Ni), cobalt (Co) and molybdenum (Mo), or any alloy of these metals.

In an exemplary embodiment, each of the conductive wire patterns 120 may have a width of, but not limited to, about 10 nm to about 200 nm as long as it may exhibit polarization performance. In an exemplary embodiment, each of the conductive wire patterns 120 may have a thickness of, but not limited to, about 10 nm to about 500 nm.

At least some of the conductive wire patterns 120 extending in a direction may include flaws provided in a direction different from the direction in which the conductive wire patterns 120 extend. When seen in horizontal cross-section, the flaws may protrude laterally to the extending direction of the conductive wire patterns 120. Accordingly, the flaws may respectively increase gaps between conductive wire patterns having the flaws and adjacent conductive wire patterns. Thus, light of unwanted polarizations may transmit through the increased gaps.

The invention includes the blocking portions 122a and 122b which block the flaws to prevent light of unwanted polarizations from transmitting through the gaps. More specifically, the conductive wire patterns 120 may exhibit polarization characteristics because they have a predetermined period as described above. However, the flaws protruding laterally to the extending direction of the conductive wire patterns 120 may affect the period. That is, the protruding flaws may respectively increase distances between conductive wire patterns having the flaws and adjacent conductive wire patterns, thereby deteriorating the polarization characteristics. Therefore, the blocking portions 122a and 122b may be provided in areas where the flaws exist in order to prevent light from transmitting through these areas.

Generally, a bright spot, that is, an image provided by unwanted light transmitting through an area is easily visible to a viewer. A dark spot, that is, an area through which light does not transmit is relatively less visible to a viewer. Therefore, a blocking portion may be provided in a conductive wire pattern having a flaw in order to make this area as a dark spot. Accordingly, a defect due to the bright spot may be prevented.

The blocking portions 122a and 122b may be integrally provided with the conductive wire patterns 120. Referring to FIGS. 1 through 3, the blocking portions 122a and 122b may be integrally provided with conductive wire patterns 121a and 121b having flaws, respectively. Therefore, the blocking portions 122a and 122b may protrude from respective side surfaces of the conductive wire patterns 121a and 121b, respectively.

That is, the blocking portions 122a and 122b may be provided by partially melting the conductive wire patterns 121a and 121b, respectively. In an exemplary embodiment, the blocking portions 122a and 122b may include the same material as the conductive wire patterns 121a and 121b, for example. This will be described in more detail later.

The blocking portions 122a and 122b may be wider than the conductive wire patterns 121a and 121b. This prevents an unwanted increase in a distance between each of the conductive wire patterns 121a and 121b and an adjacent conductive wire pattern, thereby preventing the formation of bright spots.

More specifically, distances between each of the blocking portions 122a and 122b and conductive wire patterns adjacent to both sides of the conductive wire pattern 121a or 121b having the blocking portion 122a or 122b may be equal to or smaller than a distance between conductive wire patterns 121 without blocking portions. That is, distances between each of the blocking portions 122a and 122b and conductive wire patterns located on both sides thereof may be equal to or smaller than the distance between the conductive wire patterns 121 without blocking portions. Referring to FIGS. 1 through 3, a distance between the blocking portion 122a provided in the conductive wire pattern 121a having a flaw and a conductive wire pattern located on a left side of the blocking portion 122a is smaller than the distance between the conductive wire patterns 121 without flaws. In addition, a distance between the blocking portion 122a and a conductive wire pattern located on a right side of the blocking portion 122a is equal to the distance between the conductive wire patterns 121 without flaws.

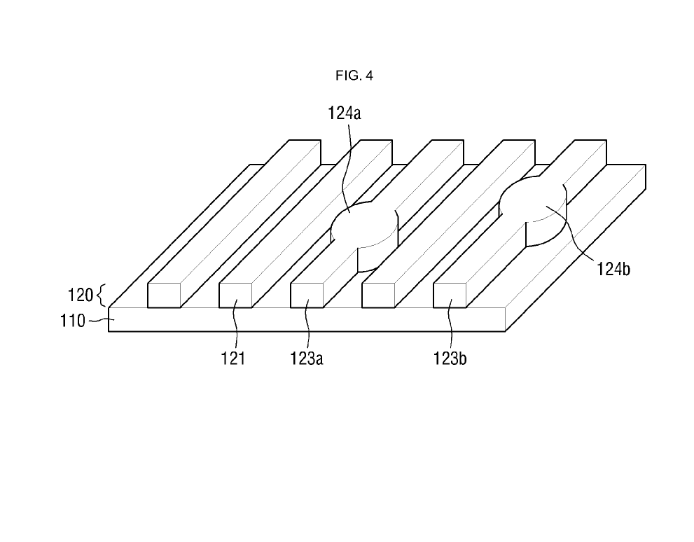

FIG. 4 is a perspective view of a wire grid polarizer according to another exemplary embodiment of the invention. Referring to FIG. 4, blocking portions 124a and 124b may protrude from both sides of conductive wire patterns 123a and 123b having the blocking portions 124a and 124b. As described above, the blocking portions 124a and 124b may be provided by partially melting conductive wire patterns 123a and 123b. Accordingly, each of the blocking portions 124a and 124b may protrude from both sides of one of the conductive wire patterns 123a and 123b, respectively. Other elements are identical to those described above, and thus a redundant description thereof is omitted.

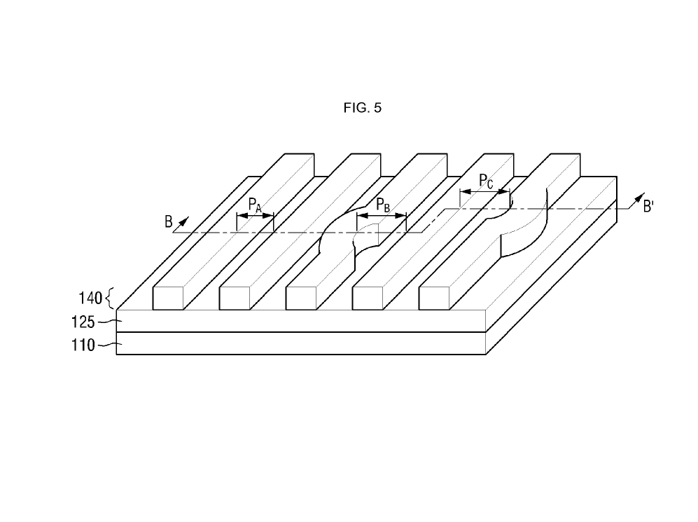

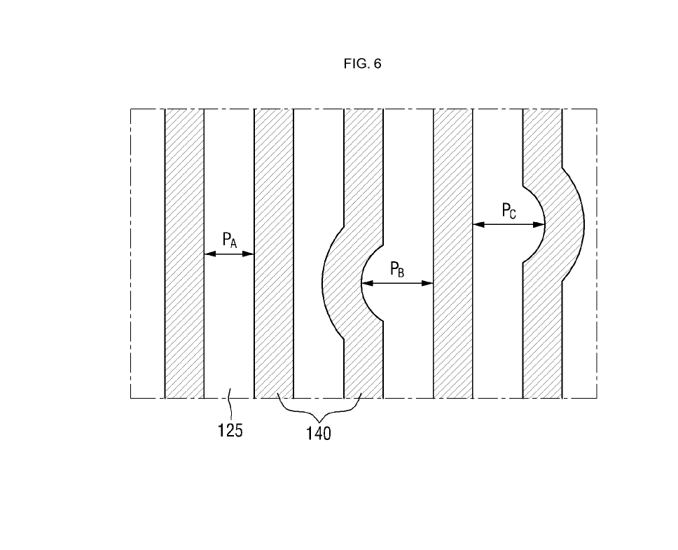

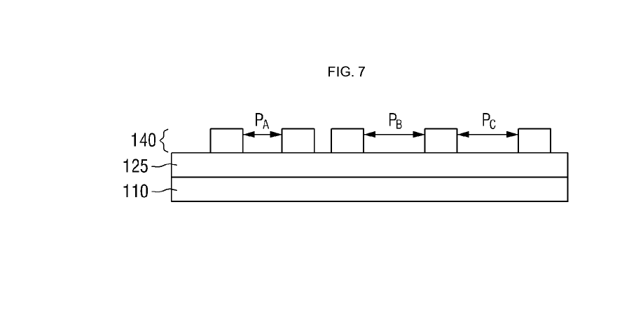

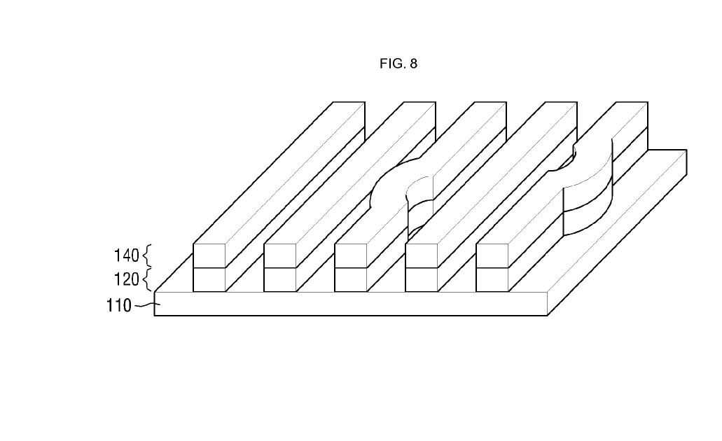

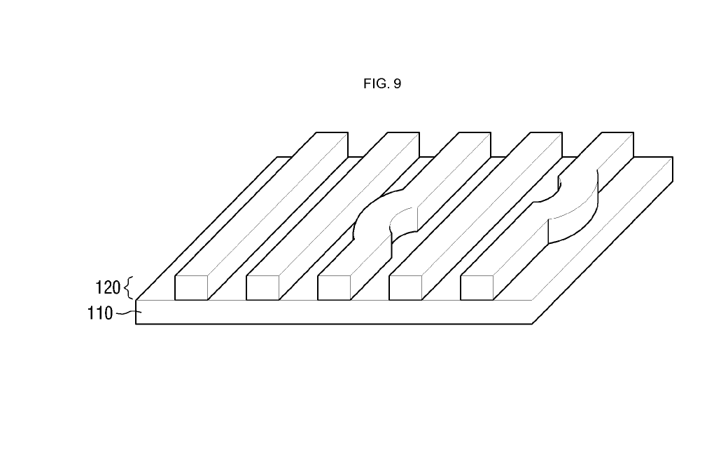

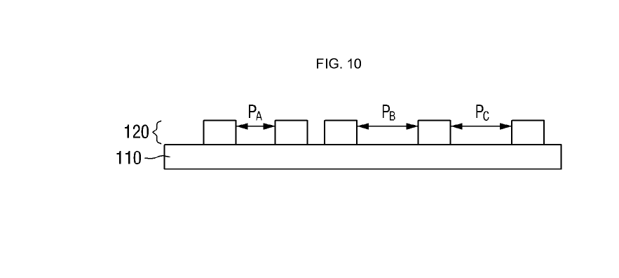

FIGS. 5 through 11 are schematic views illustrating a method of fabricating a wire grid polarizer such as those described above. A method of fabricating a wire grid polarizer according to an exemplary embodiment of the invention will now be described with reference to FIGS. 5 through 11. FIG. 6 is a plan view of the resultant structure of the process of FIG. 5, and FIG. 7 is a cross-sectional view of the resultant structure taken along line B-B′ of FIG. 5. In addition, FIG. 8 is a perspective view of the resultant structure after the etching process, FIG. 9 is a perspective view of the resultant structure after the pattern layer 140 is removed, and FIG. 10 is a cross-sectional view of the resultant structure of FIG. 9.

The method of fabricating a wire grid polarizer may include forming a pattern layer on a substrate, forming conductive wire patterns by patterning the pattern layer, and melting flaws disposed on at least some of the conductive wire patterns. The melting of the flaws may be achieved by irradiating a laser beam to the flaws.

First, referring to FIG. 5, a conductive layer 125 for forming conductive wire patterns is disposed on a substrate 110, and then a pattern layer 140 is disposed on the conductive layer 125. In an exemplary embodiment, the conductive layer 125 may include a metal material, for example, a metal including, but not limited to, aluminum (Al), chrome (Cr), silver (Ag), copper (Cu), nickel (Ni), cobalt (Co) and molybdenum (Mo), or any alloy of these metals using, but not limited to, a sputtering method, a chemical vapor deposition (“CVD”) method, or an evaporation method, for example.

In an exemplary embodiment, the pattern layer 140 may be provided by, but not limited to, a nanoimprint method, a photoresist method, a double patterning method, or a block copolymer alignment patterning method, for example.

Next, referring to FIG. 8, conductive wire patterns 120 are provided by patterning the conductive layer 125 located under the patterning layer 140 using an etching process, for example. Then, the pattern layer 140 located on the conductive wire patterns 120 is removed, leaving only the conductive wire patterns 120 on the substrate 110. Since the etching process and a method of removing the pattern layer 140 are widely known to those skilled in the art to which the invention pertains, a detailed description thereof is omitted.

In the process of forming the pattern layer 140, the pattern layer 140 may be partially bent as illustrated in FIGS. 5 through 7. That is, some portions of the pattern layer 140 may be unwantedly bent in the process of forming nano-sized fine patterns of the pattern layer 140. The bent portions (i.e., flaws) of the pattern layer 140 may result from manufacturing process errors.

A distance between adjacent patterns may be greater in the bent portions of the pattern layer 140. That is, distances P_{B} and P_{C} between adjacent patterns in the bent portions may be greater than an intended distance P_{A} between adjacent patterns. This difference in distance may be transferred to the conductive wire patterns 120 as illustrated in FIGS. 9 and 10 even after the pattern layer 140 is removed. Therefore, the bent portions of the pattern layer 140 may act as flaws of the conductive wire patterns 120.

Since the distance between a conductive wire pattern having each of the flaws and an adjacent conductive wire pattern is greater than the intended distance between adjacent patterns, a polarization function may be reduced, and light of unwanted polarizations may pass through a wire grid polarizer. As a result, bright spots may be provided.

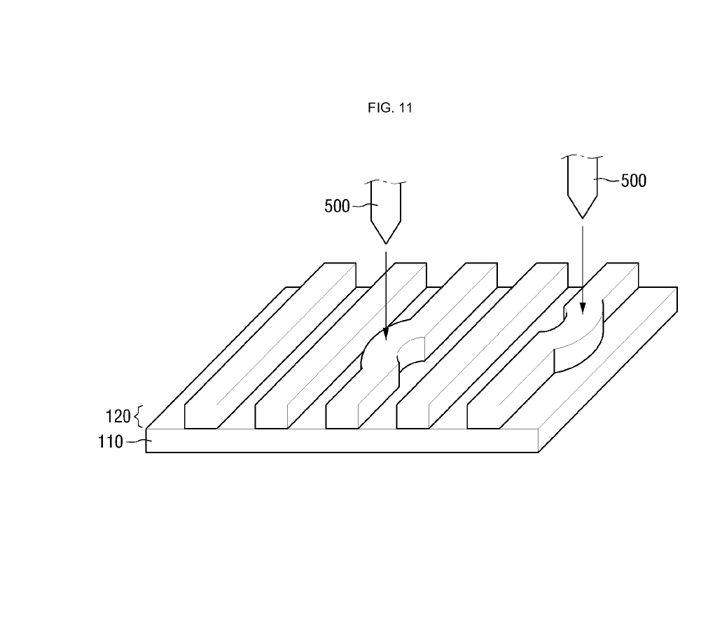

In the invention, however, blocking portions may be provided by melting areas where the flaws are provided by irradiating a laser beam 500 to the flaws as illustrated in FIG. 11. Accordingly, left and right widths of the areas where the flaws are located on the conductive wire patterns 120 may be increased. The increased left and right widths of the areas reduce the distances to adjacent conductive wire patterns, thereby preventing the formation of bright spots.

The laser beam 500 may be irradiated toward the conductive wire patterns 120 from a surface of the substrate 110. That is, the laser beam 500 may be irradiated toward the conductive wire patterns 120 from above a surface of the substrate 110 on which the conductive wire patterns 120 are provided. However, the invention is not limited thereto. When necessary, the laser beam 500 may be irradiated toward the conductive wire patterns 120 from the other surface of the substrate 110.

Although not separately illustrated, the method of fabricating a wire grid polarizer according to the invention may further include detecting the flaws before the melting of the flaws. The flaws may be detected with the naked eye using a microscope or by monitoring an image signal generated by a camera, but the invention is not limited thereto. These methods of detecting flaws are widely known to those skilled in the art to which the invention pertains, and thus a detailed description thereof is omitted.

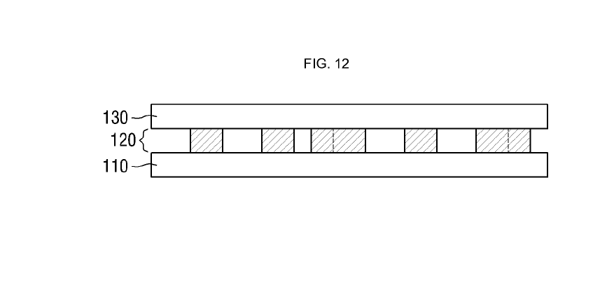

The method of fabricating a wire grid polarizer may further include forming a protective layer 130 on the conductive wire patterns 120 as illustrated in FIG. 12. The protective layer 130 is designed to form a thin-film transistor (“TFT”) of a lower panel of a display device which will be described later. The protective layer 130 will be described in detail later.

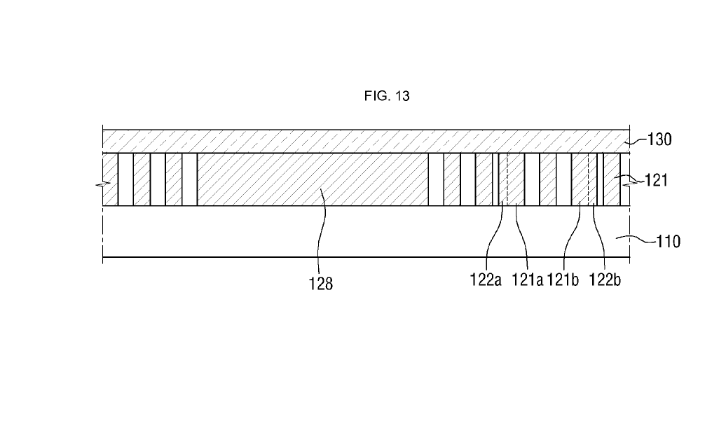

FIG. 13 is a cross-sectional view of a wire grid polarizer according to another exemplary embodiment of the invention. Referring to FIG. 13, a reflective layer 128 may additionally be disposed on a substrate 110 between conductive wire patterns 121. The reflective layer 128 may be provided in an area corresponding to a non-aperture area of a display device which will be described later. In an exemplary embodiment, the reflective layer 128 may be provided in, but not limited to, a wiring area, a transistor area, etc.

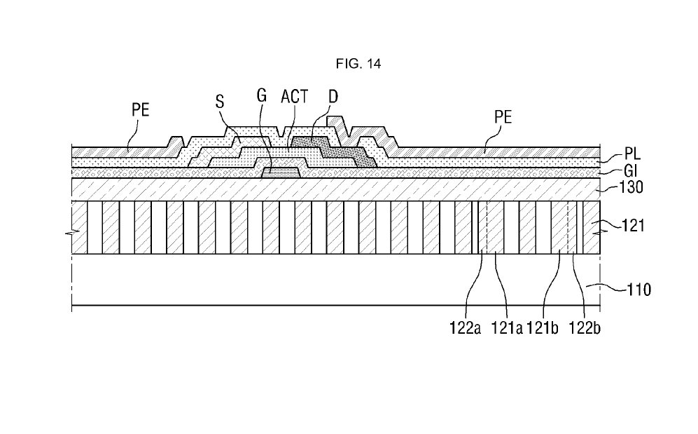

FIG. 14 is a schematic cross-sectional view of a lower panel of a display device according to an embodiment of the invention.

Referring to FIG. 14, the lower panel of the display device according to the current embodiment may be a TFT panel. The lower panel may include a substrate 110, a plurality of conductive wire patterns 121 which protrude upward from the substrate 110 and are arranged in a direction to be substantially parallel to each other, a protective layer 130 which is disposed on the conductive wire patterns 121, a gate electrode G which is located on the protective layer 130, a gate insulating layer GI which is located on the gate electrode G and the protective layer 130, a semiconductor layer ACT which is located on at least a region of the gate insulating layer GI which overlaps the gate electrode G, a source electrode S and a drain electrode D which are located on the semiconductor layer ACT to be separated from each other, a passivation layer PL which is located on the gate insulating layer GI, the source electrode S, the semiconductor layer ACT and the drain electrode D, and a pixel electrode PE which is located on the passivation layer PL via a contact hole that at least partially exposes the drain electrode D and electrically connected to the drain electrode D via the contact hole.

The protective layer 130 may be provided to make an upper surface of a wire grid polarizer non-conductive and planarize the upper surface of the wire grid polarizer. The protective layer 130 may include any non-conductive transparent material.

In an exemplary embodiment, the protective layer 130 may include, but not limited to, one or more materials including SiOx, SiNx, and SiOC, for example. In an exemplary embodiment, the protective layer 130 may have a structure including a SiOC layer stacked on a SiOx layer, for example. In this case, the SiOx layer and the SiOC layer may be deposited in the same chamber and condition by simply changing a source gas, and a deposition rate of the SiOC layer is relatively high. Therefore, it is advantageous in terms of process efficiency.

In another exemplary embodiment, transparent resin may be used, for example. In this case, the protective layer 130 may be provided by photocuring and/or thermal curing after spin coating. Therefore, process efficiency may be improved.

The display device may further include a backlight unit which is located under the lower panel and emits light, a liquid crystal panel which includes the lower panel, a liquid crystal layer and an upper panel, and an upper polarizing plate which is located on the liquid crystal panel.

In this case, transmission axes of the upper polarizing plate and the wire grid polarizer may be orthogonal or parallel to each other. In some cases, the upper polarizing plate may be configured as a wire grid polarizer or may include a conventional polyvinyl acetate (“PVA”)-based polarizing film. In other exemplary embodiments, the upper polarizing plate may be omitted.

Although not specifically illustrated, the backlight unit may include a light guide plate (“LGP”), one or more light source units, a reflective member, an optical sheet, etc.

The LGP changes the path of light generated by the light source units toward the liquid crystal layer. The LGP may include an incident surface upon which light generated by the light source units is incident and an exit surface which faces the liquid crystal layer. In an exemplary embodiment, the LGP may include, but not limited to, a material having light-transmitting properties such as polymethyl methacrylate (“PMMA”) or a material having a fixed refractive index such as polycarbonate (“PC”).

Light incident upon a side surface or both side surfaces of the LGP including the above materials has an angle smaller than a critical angle of the LGP. Thus, the light enters the LGP. When the light is incident upon an upper or lower surface of the LGP, an incidence angle of the light is greater than the critical angle. Thus, the light is evenly delivered within the LGP without exiting from the LGP.

Scattering patterns may be disposed on any one of the upper and lower surfaces of the LGP. In an exemplary embodiment, the scattering patterns may be disposed on the lower surface of the LGP which faces the exit surface so as to make guided light travel upward. That is, the scattering patterns may be printed on a surface of the LGP using ink, such that light reaching the scattering patterns within the LGP may exit upward from the LGP. The scattering patterns may be printed using ink as described above. However, the invention is not limited thereto, and the scattering patterns may take various forms such as micro grooves or micro protrusions on the LGP.

The reflective member may further be provided between the LGP and a bottom portion of a lower housing member. The reflective member reflects light output from the lower surface (which faces the exit surface) of the LGP back to the LGP. In an exemplary embodiment, the reflective member may be in the form of, but not limited to, a film, for example.

The light source units may be placed to face the incident surface of the LGP. The number of the light source units may be changed as desired. In an exemplary embodiment, only one light source unit may be provided to correspond to a side surface of the LGP, or three or more light source units may be provided to correspond to three or more of four side surfaces of the LGP. In an alternative exemplary embodiment, a plurality of light source units may be placed to correspond to any one of the side surfaces of the LGP. While a side light structure in which a light source is placed on a side of the LGP has been described as an example, a direct light structure, a surface light source structure, etc. may also be used according to the configuration of the backlight unit.

In an exemplary embodiment, a light source used may be a white light-emitting diode (“LED”) which emits white light or may include a plurality of LEDs which emit red light, green light and blue light, for example. When the light source is implemented as a plurality of LEDs which emit red light, green light and blue light, for example, the LEDs may be turned on simultaneously to produce white light through color mixing.

Although not separately illustrated, the upper panel may be a color filter (“CF”) panel. In an exemplary embodiment, the upper panel may include a black matrix for preventing the leakage of light, red, green and blue color filters, and a common electrode (i.e., an electric field-generating electrode) including transparent conductive oxide such as indium tin oxide (“ITO”) or indium zinc oxide (“IZO”). In an exemplary embodiment, the black matrix, the red, green and blue color filters, and the common electrode may be disposed on a lower surface of a member including a transparent insulating material such as glass or plastic.

The liquid crystal layer rotates a polarization axis of incident light. The liquid crystal layer is aligned in a predetermined direction and located between the upper panel and the lower panel. In an exemplary embodiment, the liquid crystal layer may include, but not limited to, a twisted nematic (“TN”), vertical alignment (“VA”), or horizontal alignment (e.g., IPS, FFS) mode having positive dielectric anisotropy, for example.

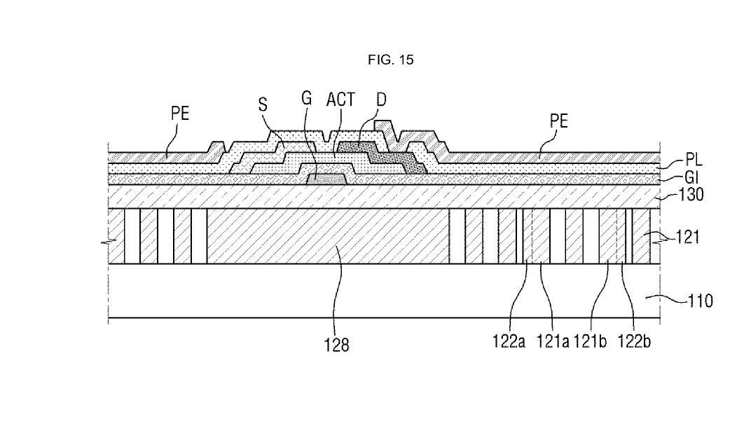

FIG. 15 is a schematic cross-sectional view of a lower panel of a display device according to another exemplary embodiment of the invention.

Referring to FIG. 15, the lower panel may be a TFT panel. The lower panel may include a substrate 110, a plurality of parallel conductive wire patterns 121 which protrude upward from the substrate 110, a reflective layer 128 which is disposed on the substrate 110 between the conductive wire patterns 121, a protective layer 130 which is disposed on the conductive wire patterns 121 and the reflective layer 128, a gate electrode G which is located on the protective layer 130, a gate insulating layer GI which is located on the gate electrode G and the protective layer 130, a semiconductor layer ACT which is located on at least a region of the gate insulating layer GI which overlaps the gate electrode G, a source electrode S and a drain electrode D which are located on the semiconductor layer ACT to be separated from each other, a passivation layer PL which is located on the gate insulating layer GI, the source electrode S, the semiconductor layer ACT and the drain electrode D, and a pixel electrode PE which is located on the passivation layer PL via a contact hole that at least partially exposes the drain electrode D and electrically connected to the drain electrode D via the contact hole.

An area in which a TFT including the gate electrode G, the semiconductor layer ACT, the source electrode S and the drain electrode D is located is an area through which light does not transmit. The area is called a non-aperture area. Therefore, the reflective layer 128 without the conductive wire patterns 121 of a wire grid polarizer may be provided at a location corresponding to the non-aperture area. In this case, a metal material having high reflectivity may reflect light incident upon the non-aperture area, and the reflected light may be used in an aperture area. Therefore, the luminance of the display device may be improved.

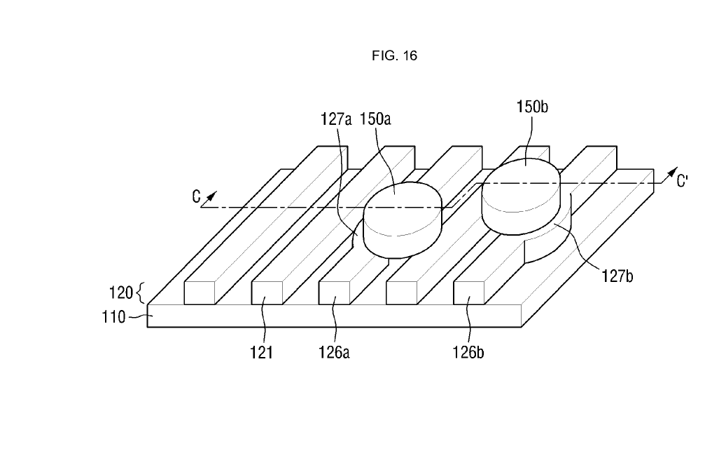

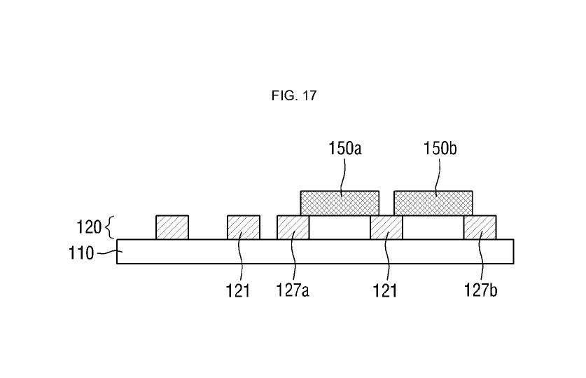

FIG. 16 is a perspective view of a wire grid polarizer according to another exemplary embodiment of the invention. FIG. 17 is a cross-sectional view taken along line C-C′ of FIG. 16.

Referring to FIGS. 16 and 17, blocking portions 150a and 150b may be located on conductive wire patterns 126a and 126b having flaws 127a and 127b. In addition, the blocking portions 150a and 150b may be respectively located on the conductive wire patterns 126a and 126b having the flaws 127a and 127b, respectively, and conductive wire patterns adjacent to the conductive wire patterns 126a and 127b.

In other words, the blocking portions 150a and 150b may be located on the flaws 127a and 127b and the conductive wire patterns adjacent to the flaws 127a and 127b. Each of the blocking portions 150a and 150b provided as described above may block light from passing through an increased gap between adjacent conductive wire patterns by one of the flaws 127a and 127b. Specifically, the blocking portions 150a and 150b may block light in a visible range. That is, since the blocking portions 150a and 150b block light in the range visible to a viewer, the blocking portions 150a and 150b may prevent the viewer from recognizing bright spots.

In an exemplary embodiment, the blocking portions 150a and 150b described above may include a material that includes a photosensitive resin composition, for example, a negative photosensitive resin composition. Here, the negative photosensitive resin composition refers to a resin composition whose portions exposed to light are cured. The effects obtained when the blocking portions 150a and 150b include the material that includes the photosensitive resin composition may include ease of flaw detection in a fabrication process which will be described later and ease of the fabrication process. These effects will be described later.

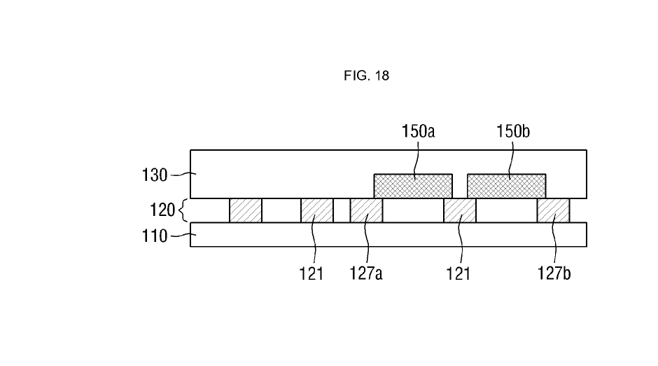

FIG. 18 is a cross-sectional view of a wire grid polarizer according to another exemplary embodiment of the invention. Referring to FIG. 18, a protective layer 130 may cover blocking portions 150a and 150b and upper surfaces of conductive wire patterns 120 to planarize an upper surface of the wire grid polarizer. Since the protective layer 130 has been described above, a redundant description thereof is omitted.

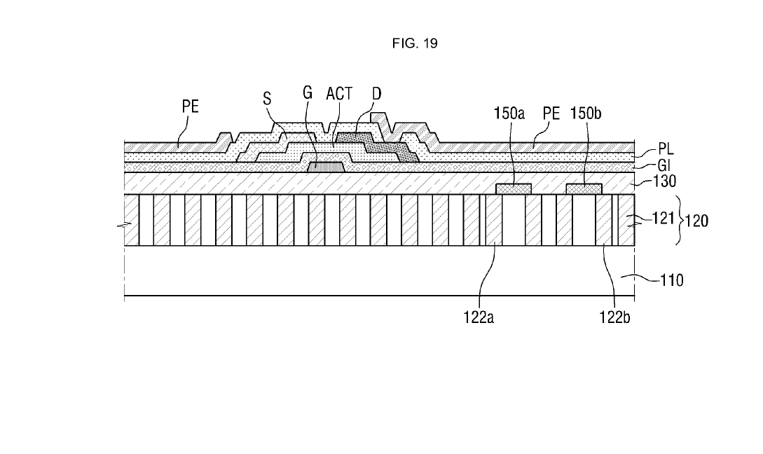

FIG. 19 is a cross-sectional view of a lower panel including the wire grid polarizer of FIG. 18. Referring to FIG. 19, the blocking portions 150a and 150b may be located in an aperture area. However, the invention is not limited thereto.

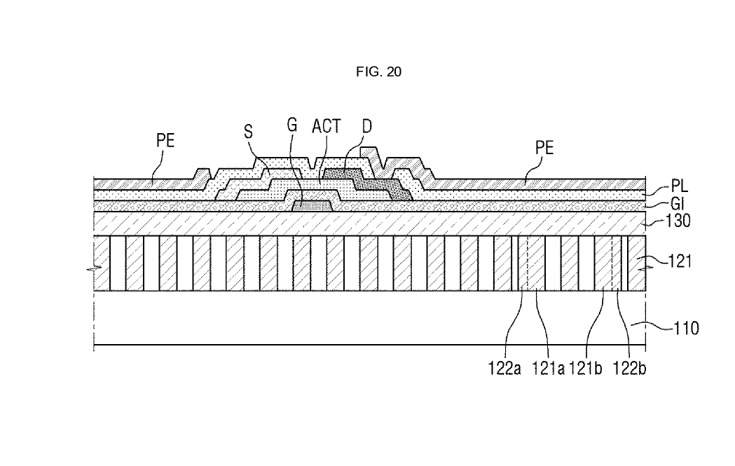

FIG. 20 is a cross-sectional view of a lower panel according to another exemplary embodiment of the invention. Referring to FIG. 20, a reflective layer 128 may further be provided between conductive wire patterns 121. The reflective layer 128 may be provided at a location corresponding to a non-aperture area. In this case, blocking portions 150a and 150b may be located only in an aperture area.

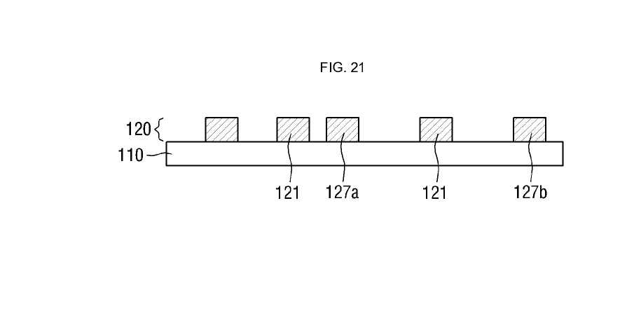

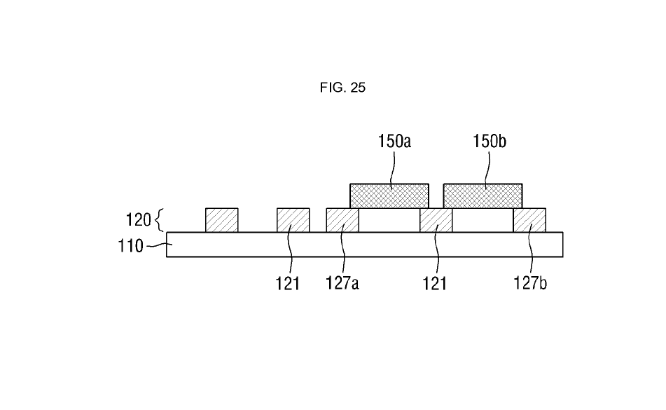

FIGS. 21 through 25 are schematic views illustrating a method of fabricating a wire grid polarizer according to another exemplary embodiment of the invention.

Referring to FIGS. 21 through 25, the method of fabricating a wire grid polarizer according to the current embodiment may include forming a pattern layer on a surface of a substrate, forming conductive wire patterns by patterning the pattern layer, coating a photosensitive layer, which includes a photosensitive resin composition, on the conductive wire patterns, forming blocking portions by exposing the photosensitive layer to light, and removing the photosensitive layer excluding the blocking portions.

First, referring to FIG. 21, conductive wire patterns 120 are disposed on a substrate 110. Since a method of forming the conductive wire patterns 120 has been described above, a redundant description thereof is omitted.

As illustrated in FIG. 21, the conductive wire patterns 120 may include conductive wire patterns 127a and 127b having unwanted flaws. These flaws may increase gaps between the conductive wire patterns 127a and 127b and adjacent conductive wire patterns 121. Accordingly, unwanted polarized light may transmit through the increased gaps as described above.

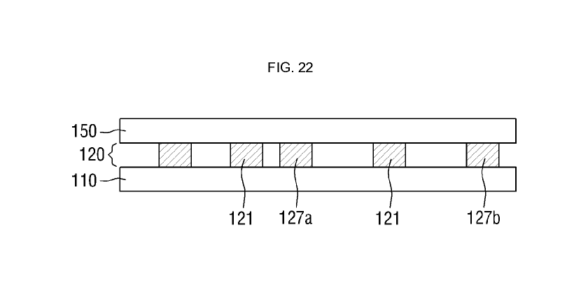

Next, referring to FIG. 22, a photosensitive layer 150 which includes a photosensitive resin composition is coated on the conductive wire patterns 120. In an exemplary embodiment, the photosensitive layer 150 may include a negative photosensitive resin composition as described above.

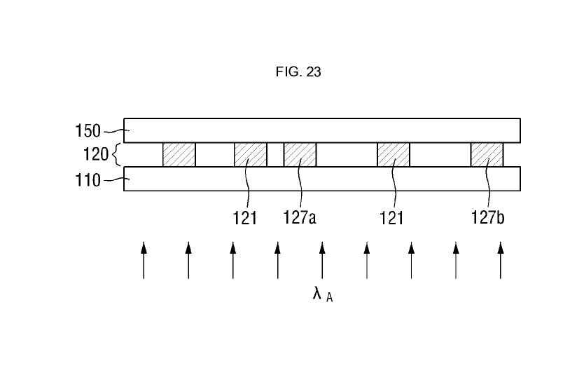

Referring to FIG. 23, blocking portions 150a and 150b are provided by exposing the photosensitive layer 150 to light. The forming of the blocking portions 150a and 150b may be achieved by irradiating light λ_{A} toward the photosensitive layer 150 from a surface of the substrate 110 on which the conductive wire patterns 120 are not provided. That is, the irradiated light λ_{A} may transmit through the substrate 110 and the conductive wire patterns 120 to reach the photosensitive layer 150.

In an exemplary embodiment, the irradiated light λ_{A} may be light of a first polarization substantially parallel to a direction in which the conductive wire patterns 120 are arranged substantially parallel to each other.

In a case where conductive wire patterns are arranged in a direction with a predetermined period, most of light polarized in a direction perpendicular to the arrangement direction may substantially transmit through the conductive wire patterns, and most of light polarized in a direction parallel to the arrangement direction may fail to transmit through the conductive wire patterns.

Therefore, when the light λ_{A} of the first polarization substantially parallel to the arrangement direction of the conductive wire patterns 120 is irradiated as in the invention, it may not transmit through locations where flaws are not provided (i.e., locations where desired conductive wire patterns are provided) and may transmit through locations where flaws are provided.

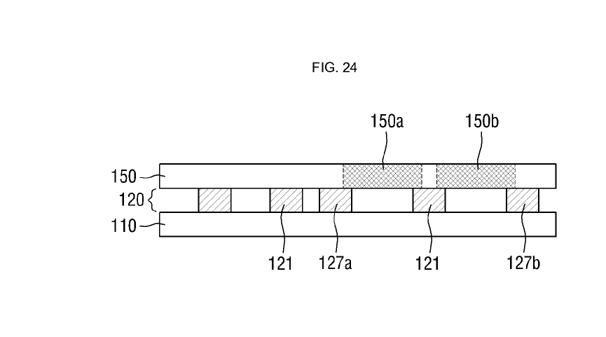

Accordingly, the light λ_{A} may reach only the photosensitive layer 150 located on the conductive wire patterns 127a and 127b having the flaws and the conductive wire patterns 121 adjacent to the conductive wire patterns 127a and 127b, and only areas where the blocking portions 150a and 150b are provided may be cured as illustrated in FIG. 24. That is, the forming of the blocking portions 150a and 150b may be achieved by transmitting the light λ_{A} of the first polarization through the conductive wire patterns 120 and letting areas of the photosensitive layer 150, which are exposed to the light λ_{A} of the first polarization, be cured.

Other areas of the photosensitive layer 150 excluding the areas where the blocking portions 150a and 150b are provided are removed. As a result, the blocking portions 150a and 150b are provided only on the conductive wire patterns 127a and 127b having the flaws and the conductive wire patterns 121 adjacent to the conductive wire patterns 127a and 127b.

As described above, the blocking portions 150a and 150b block light in a visible wavelength range, thereby preventing bright spots from being observed by a viewer.

Embodiments of the invention provide at least one of the following advantages.

It is possible to prevent bright spot defects by blocking flaws provided in a wire grid polarizer.

It is also possible to repair flaws provided in the process of fabricating a wire grid polarizer.

While the invention has been particularly shown and described with reference to exemplary embodiments thereof, it will be understood by those of ordinary skill in the art that various changes may be made therein without departing from the spirit and scope of the invention as defined by the following claims. The exemplary embodiments should be considered in a descriptive sense only and not for purposes of limitation.

What is claimed is:

1. A wire grid polarizer comprising:
a substrate;
a plurality of conductive wire patterns which protrudes from a surface of the substrate and each extends in a direction to be substantially parallel to each other;
a flaw which is provided in at least one of the plurality of conductive wire patterns and protrudes in a direction different from the direction in which the plurality of conductive wire patterns extend; and
a blocking portion which blocks the flaw.

2. The wire grid polarizer of claim 1, wherein the blocking portion is integrally provided with a conductive wire pattern of the plurality of conductive wire patterns having the flaw.

3. The wire grid polarizer of claim 2, wherein the blocking portion is wider than the conductive wire pattern having the flaw.

4. The wire grid polarizer of claim 2, wherein distances between the blocking portion and conductive wire patterns adjacent to both sides of the conductive wire pattern including the blocking portion are equal to or smaller than a distance between conductive wire patterns without blocking portions.

5. The wire grid polarizer of claim 2, wherein the blocking portion includes the same material as the conductive wire pattern having the flaw.

6. The wire grid polarizer of claim 1, wherein the blocking portion is located on a conductive wire pattern of the plurality of conductive wire patterns having the flaw.

7. The wire grid polarizer of claim 6, wherein the blocking portion is located on the conductive wire pattern having the flaw and a conductive wire pattern adjacent to the conductive wire pattern.

8. The wire grid polarizer of claim 6, wherein the blocking portion blocks light in a visible wavelength range.

9. The wire grid polarizer of claim 8, wherein the blocking portion includes a negative photosensitive resin composition.

10. The wire grid polarizer of claim 1, further comprising a reflective layer located on the substrate between the conductive wire patterns.

11. A method of fabricating a wire grid polarizer, the method comprising:
forming a pattern layer on a substrate;
forming conductive wire patterns by patterning the pattern layer; and
melting a flaw provided in at least one of the conductive wire patterns.

12. The method of claim 11, wherein the melting of the flaw is performed by irradiating a laser beam to the flaw.

13. The method of claim 12, wherein the laser beam is irradiated toward the conductive wire patterns from a surface of the substrate.

14. The method of claim 11, further comprising detecting the flaw before the melting of the flaw.

15. A method of fabricating a wire grid polarizer, the method comprising:
forming a pattern layer on a surface of a substrate;
forming conductive wire patterns by patterning the pattern layer;
coating a photosensitive layer, which includes a photosensitive resin composition, on the conductive wire patterns;
forming a blocking portion by exposing the photosensitive layer to light; and
removing the photosensitive layer excluding the blocking portion.

16. The method of claim 15, wherein the photosensitive resin composition comprises a negative photosensitive resin composition.

17. The method of claim 15, wherein the blocking portion blocks light in a visible wavelength range.

18. The method of claim 15, wherein the forming the blocking portion is performed by irradiating light toward the photosensitive layer from the other surface of the substrate.

19. The method of claim 18, wherein the conductive wire patterns are arranged in a direction to be substantially parallel to each other, and the light is light of a first polarization parallel to the direction in which the conductive wire patterns are arranged.

20. The method of claim 19, wherein the forming the blocking portion comprises transmitting the light of the first polarization through the conductive wire patterns and letting a portion of the photosensitive layer, which is exposed to the transmitted light, be cured.
